(19) United States
(12) Patent Application Publication
(10) Pub. No.: US 2006/0066129 A1
(43) Pub. Date: Mar. 30, 2006

(54) JR dashboard shader

(76) Inventor: Jessey Roger, Secane, PA (US)

Correspondence Address: ALUN L. PALMER, PATENT AGENT, 4300 PINEY CHURCH ROAD, WALDORF, MD, 20602, US

(21) Appl. No.: 10/948,340

(22) Filed: Sep. 24, 2004

(51) Int. Cl. B60J 3/00

(52) U.S. Cl. 296/97.7

(57) ABSTRACT

A system designed to provide shade for the driver and the front passenger in an aoutomobile. Shades can be flipped up and either pulled out or power driven out to provide shade. Any suitable shapes and materials may be employed for the shades.

### BACKGROUND OF THE INVENTION

1. Field of the Invention

The invention relates to shades. More particularly, the invention relates to a dashboard shade that may be implemented as a flip up, manually pulled out or mechanically driven out shade, on or in an automobile dashboard.

2. Discussion of the Background

There are many types of shades on the market: window shades, door shades, hats, caps to car overhead shades which are designed to cover from sunlight.

### SUMMARY

The sunshade of the present invention provides shade for the driver and for the front passenger when needed.

An advantage of the present invention is that the shade stays flat and can be pushed in or driven in so that the front end of the shade sits flat to the dashboard surface, hence the design of the dashboard looks the same way it was designed to look without the shade.

An additional advantage of the present invention is that when the shader is flipped up or slid out for shade, it will have less angle to its vertical than a normal dashboard angle to its vertical which helps the head sunlight heat to throw (reflect) back out rather than reflecting in towards the driver.

Another advantage of the present invention is that it helps the air conditioner to work more efficiently on hot days.

Another advantage of the present invention is that it prevents the driver's and front passenger's hands from becoming sunburned.

And, this shader can be modified and slid up from inside of the front doors for shade.

### BRIEF DESCRIPTION OF THE DRAWINGS

FIG. 1 is a left view that shows the driver side shader and the passenger side shader pulled out from the shade according to a preferred embodiment of the invention.

FIG. 2 is a left view that shows a close-up of the view of FIG. 1.

FIG. 3 is an isometric view of the embodiment of FIG. 1 showing both shaders pulled out.

FIG. 4 is a left view that shows the driver's side only with the power system not driven out, so that the front of the shader will stay flat to the dashboard surface.

FIG. 5 is a left view that shows the arrangement of FIG. 4 where the shader has been pulled out for shade.

FIG. 6 is an isometric view that shows the whole of FIG. 4 and FIG. 5.

### DETAILED DESCRIPTION

A more complete understanding of the present invention may be derived from detailed description and claims when considered in connection with the several views where reference letters represent similar items throughout the figures.

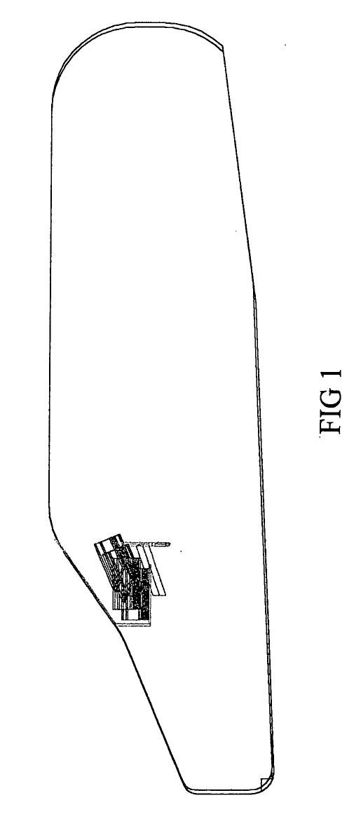

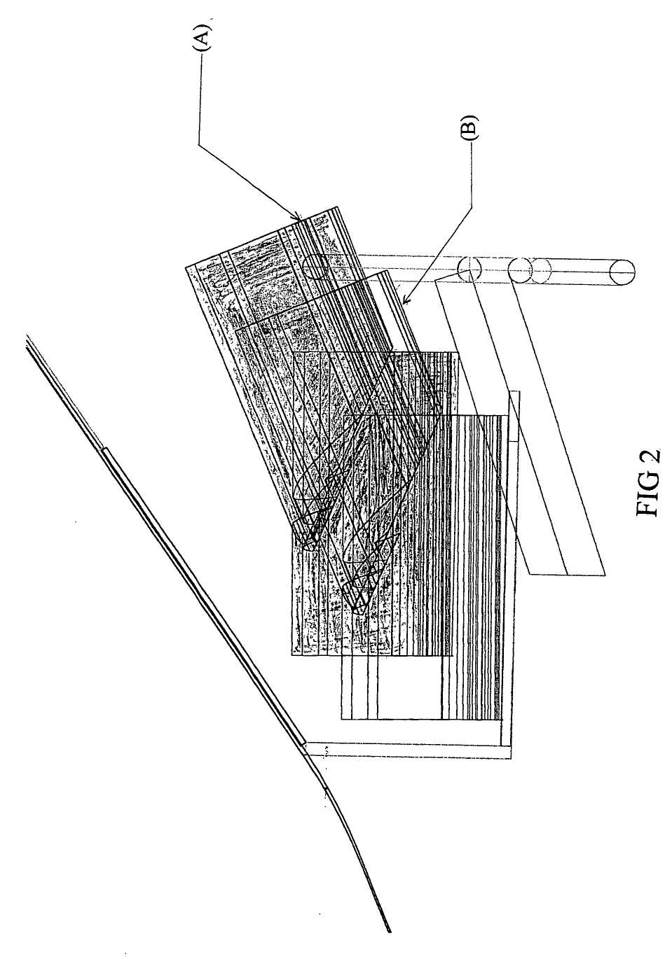

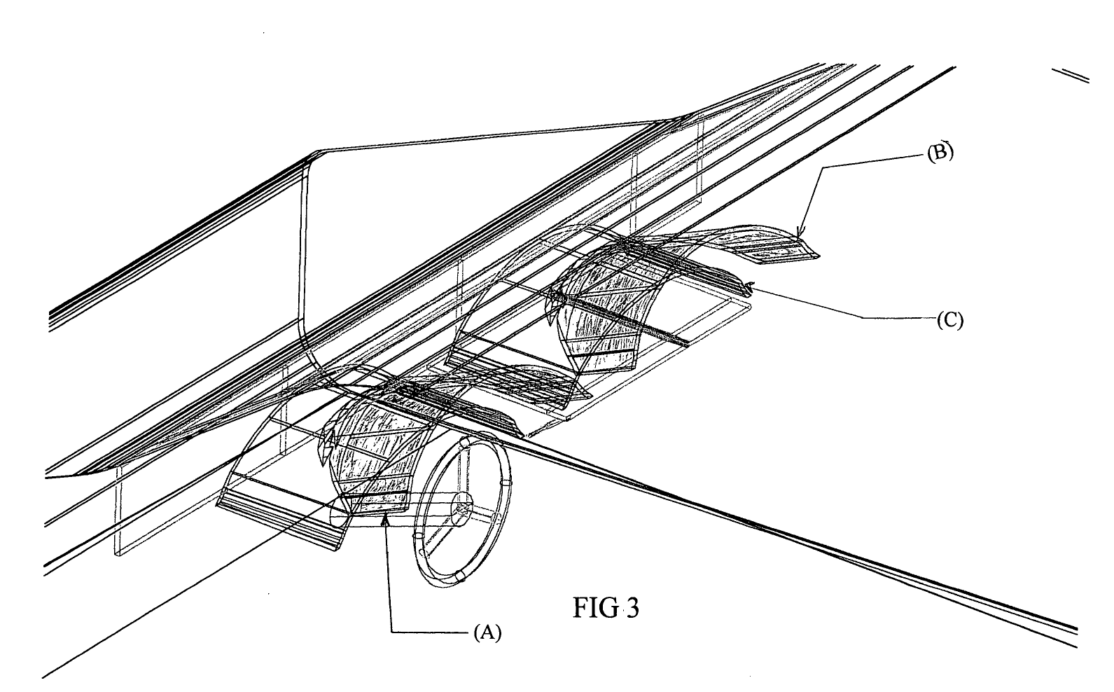

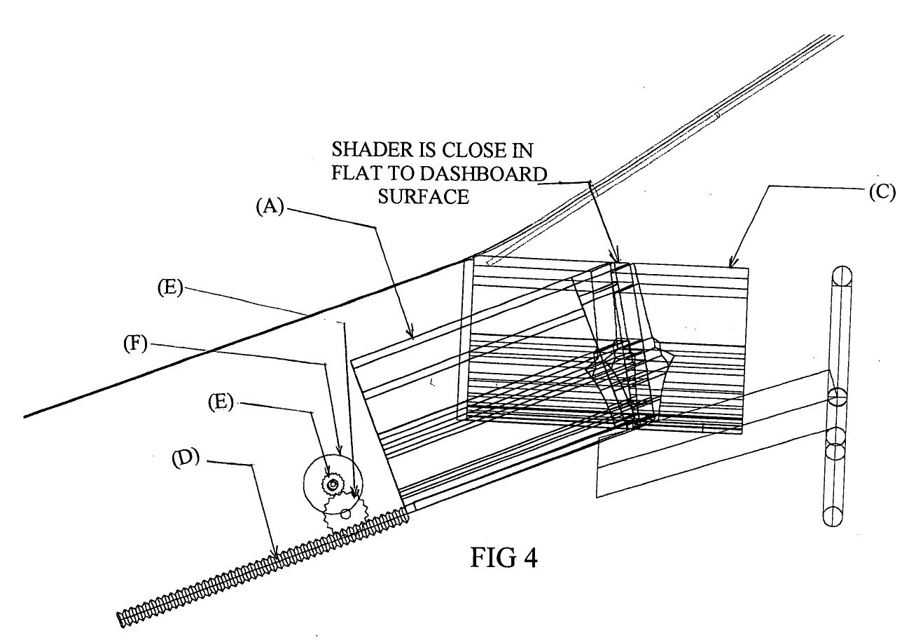

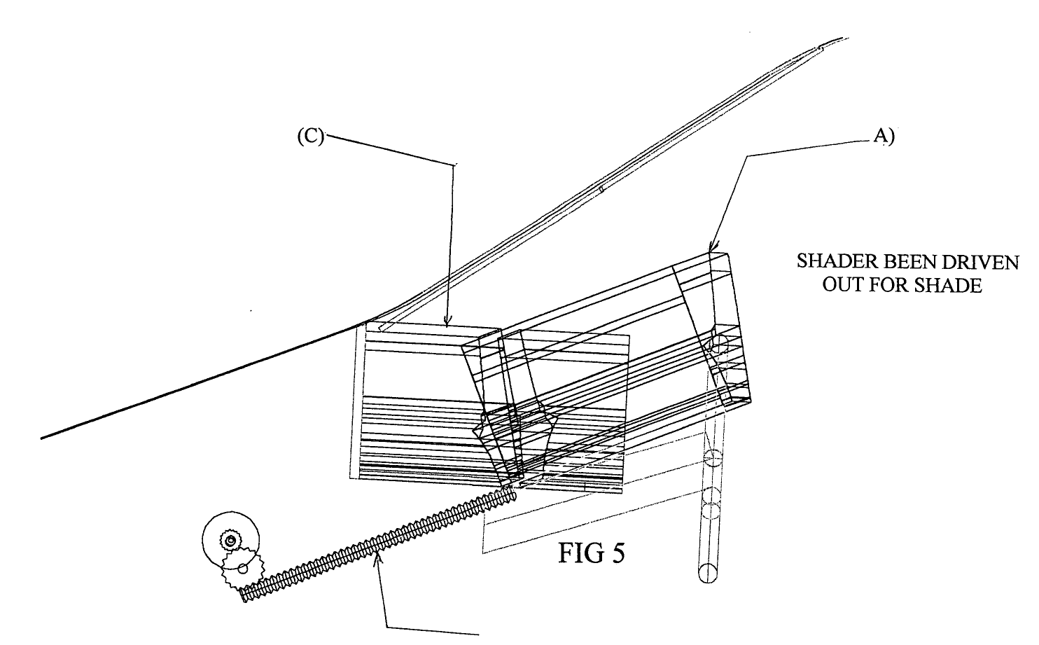

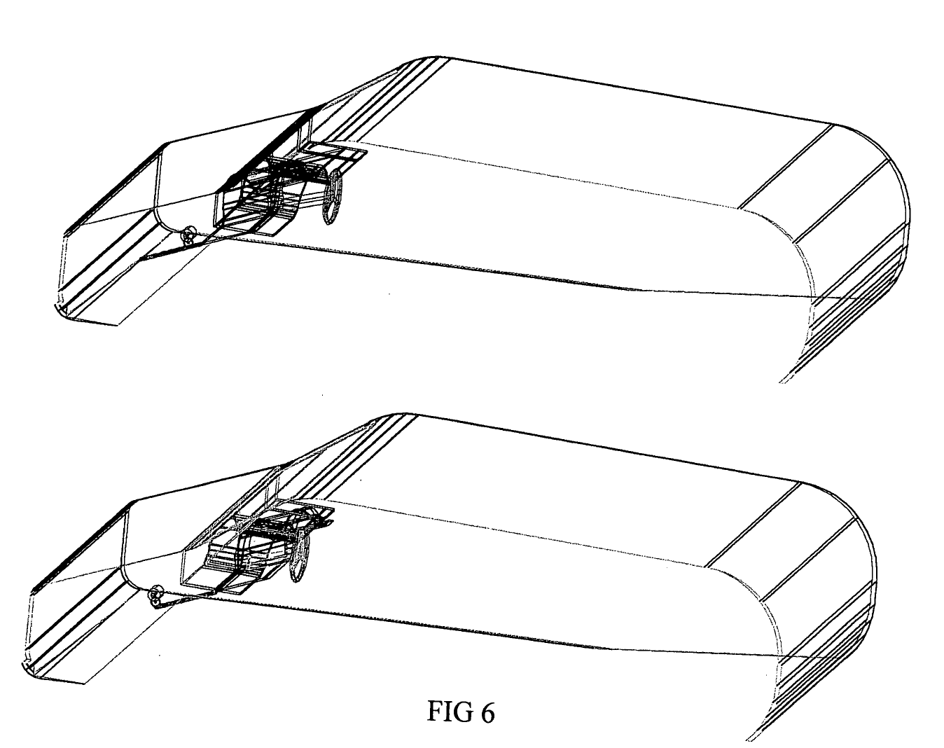

Throughout FIG. 1-6, A represents the driver's side shade; B is the passenger side shade; C is the vehicle dashboard; D is a gear shaft or rack; E represents gear wheels or pinions; and F is an electric motor.

Each shade A or B is pivotally attached to a rack D and is mounted either on or in the dashboard C. In operation, shade A or B is either pulled or driven out and may also be flipped up. In a power driven embodiment, motor F drives gear shaft or rack D via gear wheels or pinions E. Any suitable shapes and materials may be employed for the shades.

As will readily be appreciated by those skilled in the art, numerous modifications and variations of the above embodiments of the present invention are possible without departing from the scope of the invention.

1-6. (canceled)

7. An apparatus mounted on a vehicle dashboard to give shade to at least one of a driver and a front-seat passenger, comprising:
at least one shade configured to be driven by at least one rack; and
a pinion configured to cooperate with said at least one rack.

8. The apparatus according to claim 7, further comprising:
a motor configured to drive said pinion,
whereby said at least one shade is driven out by said motor.

9. The apparatus according to claim 7, wherein:
said at least one shade is configured to pivot relative to said dashboard.

10. The apparatus according to claim 7, wherein:
said at least one shade is arcuate in shape,
whereby said shade may pass over a steering wheel.

11. The apparatus according to claim 7, wherein:
said shade is configured to pass over a steering wheel.

12. The apparatus according to claim 7, wherein:
said shade is configured to lie on said dashboard when not in use.

13. An apparatus configured to give shade to a vehicle occupant, comprising:
a shade configured to be driven towards said occupant; and
a motor configured to drive said shade.

14. The apparatus according to claim 13, further comprising:
a rack configured to drive said shade; and
a pinion cooperating with said rack;
said motor configured to drive said pinion.

15. The apparatus according to claim 13, wherein:
said shade is configured to pivot relative to said occupant.

16. The apparatus according to claim 13, wherein:
said shade is mounted in a dashboard of said vehicle.

17. An apparatus comprising a shade mounted in a vehicle dashboard, wherein:
said shade is configured to be retracted into said dashboard in a first position and to extend out of said dashboard in a second position.

18. The apparatus according to claim 17, further comprising:
a motor configured to drive said shade out of said dashboard and to retract said shade into said dashboard.

19. The apparatus according to claim 17, further comprising:
a rack; and
a pinion configured to cooperate with said rack;
said rack configured to cooperate with said shade.

20. The apparatus according to claim 19, further comprising:
said motor configured to drive said pinion,
whereby said shade is driven out by said motor.

21. The apparatus according to claim 20, wherein:
said shade is configured to pivot relative to said dashboard
